(19) United States
(12) Patent Application Publication
(10) Pub. No.: US 2021/0065612 A1
(43) Pub. Date: Mar. 4, 2021

(54) SIGNAL ADJUSTMENT METHOD AND CIRCUIT, AND DISPLAY DEVICE

(71) Applicant: HKC CORPORATION LIMITED, Shenzhen (CN)

(72) Inventor: Mingliang WANG, Shenzhen (CN)

(21) Appl. No.: 17/043,107

(22) PCT Filed: Nov. 26, 2018
(86) PCT No.: PCT/CN2018/117366

§ 371 Date: Sep. 29, 2020

(30) Foreign Application Priority Data
Oct. 30, 2018 (CN) 201811277605.X

(51) Int. Cl. G09G 3/20; G09G 3/36

(52) U.S. Cl. CPC G09G 3/2096; G09G 2310/08; G09G 3/3685

(57) ABSTRACT

A signal adjustment method, comprises: accessing a clock signal and current line data signals, and identifying the transmission amplitudes of the data signals on clock signal edges; converting the transmission amplitudes into corresponding numbers; performing operation on the numbers to obtain numerical information about the transmission amplitude; and correspondingly adjusting the transmission amplitude of an output data signal according to the numerical information.

### CROSS REFERENCE TO RELATED APPLICATIONS

This application claims priority to Chinese Patent Application No. 201811277605X, filed with the Chinese Patent Office on Oct. 30, 2018 and entitled “SIGNAL ADJUSTMENT METHOD AND CIRCUIT, AND DISPLAY DEVICE”, which is incorporated herein by reference in its entirety.

### TECHNICAL FIELD

This application relates to a signal adjustment method and circuit, and a display device.

### BACKGROUND

The description herein provides only background information related to this application, but does not necessarily constitute the existing technology.

With the increase of the size and resolution of liquid crystal display televisions, data to be transmitted has increased day by day; therefore, differential signals, as a high-speed transmission protocol, are popularized, data transmission quality also faces more severe challenges, and only when voltage amplitudes, which correspond to high and low levels of data, meet certain requirements, can data be stored in a register to be transmitted correctly.

However, as differential pair quantity increases, the driver boards become increasingly thinner, and transmitted data increases and constantly changes, the amplitude status of actually received data is complicated and changeable, which leads to an even worse amplitude status of the transmitted data, and thus costs a lot of time and labor for manual debugging in practical application to ensure the differential transmission status of each signal pair. In addition, because of the constantly changing transmitted data, it is unable to ensure the reception accuracy of each batch of data.

### SUMMARY

According to various embodiments disclosed by this application, a signal adjustment method and circuit, and a display device are provided.

A signal adjustment method includes the following steps of:

inputting a clock signal and a current row data signal, and identifying transmission amplitudes of data signals at clock signal edges;

converting the transmission amplitudes into corresponding digits;

calculating the digits to obtain digital information of the transmission amplitudes; and

correspondingly adjusting and outputting the transmission amplitudes of the data signals according to the digital information.

In an embodiment, after the step of converting the transmission amplitudes into corresponding digits, the step includes:

storing the transmission amplitudes and the corresponding digits thereof.

In an embodiment, after the step of calculating the digits to obtain digital information of the transmission amplitudes, the step includes:

establishing a communication connection, and transmitting the digital information.

In an embodiment, the step of establishing a communication connection, and transmitting the digital information specifically includes:

establishing a communication connection, and transmitting the digital information in real time; or

establishing a communication connection, and transmitting the digital information when the transmission of the current row data signal is stopped.

In an embodiment, a communication connection is established by using a bidirectional communication protocol.

In an embodiment, the step of correspondingly adjusting and outputting the transmission amplitudes of the data signals according to the digital information includes the following specific step of:

adjusting the digital information to be the same as a preset digital information such that the transmission amplitude of the data signal is the same as an amplitude corresponding to the preset digital information.

In an embodiment, the amplitude corresponding to the preset digital information is a first threshold.

In an embodiment, clock signal edges include a rising edge and a falling edge.

In an embodiment, the calculation method includes at least one of a mean value method and a weighting method.

A signal adjustment circuit includes:

an identification circuit, configured to input a clock signal and a current row data signal, and identify transmission amplitudes of data signals at clock signal edges;

a conversion circuit, connected to the identification circuit and configured to convert the transmission amplitudes into corresponding digits;

a calculation circuit, connected to the conversion circuit and configured to calculate the digits to obtain digital information of the transmission amplitudes; and

an adjustment circuit, connected to the identification circuit and the calculation circuit respectively, and configured to correspondingly adjust and output the transmission amplitudes of the data signals according to the digital information.

In an embodiment, the signal adjustment circuit further includes:

a storage circuit, connected between the conversion circuit and the calculation circuit and configured to store the transmission amplitudes and the corresponding digits.

In an embodiment, the signal adjustment circuit further includes:

a communication circuit, connected between the calculation circuit and the adjustment circuit and configured to establish a communication connection between the calculation circuit and the adjustment circuit, and transmit the digital information.

In an embodiment, the communication circuit includes a bidirectional communication protocol.

In an embodiment, the communication circuit includes an inter-integrated circuit (I²C) protocol.

In an embodiment, the conversion circuit includes an analog-to-digital converter.

In an embodiment, clock signal edges include a rising edge and a falling edge.

A display device includes a display panel and the signal adjustment circuit described above.

Details of one or more embodiments of this application are provided in the following accompanying drawings and descriptions. Other features and advantages of this application will become apparent from the specification, the accompanying drawings, and the claims.

### BRIEF DESCRIPTION OF THE DRAWINGS

To describe the technical solutions in the embodiments of this application more clearly, the following briefly introduces the accompanying drawings required for describing the embodiments. Apparently, the accompanying drawings in the following description show merely some embodiments of this application, and a person of ordinary skill in the art may still derive other drawings from these accompanying drawings without creative efforts.

FIG. 1 is a flowchart of a signal adjustment method according to an embodiment of this application;

FIG. 2 is an effect diagram of adjustment of data transmission amplitudes;

FIG. 3 is a flowchart of a signal adjustment method according to another embodiment of this application;

FIG. 4 is a structural diagram of a circuit corresponding to the signal adjustment method in FIG. 1 according to an embodiment of this application; and

FIG. 5 is a structural diagram of a circuit corresponding to the signal adjustment method in FIG. 3 according to another embodiment of this application.

### DETAILED DESCRIPTION OF THE EMBODIMENTS

To make the technical solutions and advantages of this application clearer and more comprehensible, the following further describes this application in detail with reference to the accompanying drawings and embodiments. It should be understood that the specific embodiments described herein are merely used to explain this application but are not intended to limit this application.

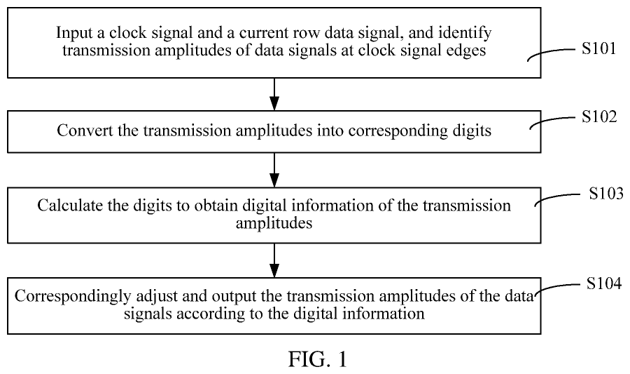

Referring to FIG. 1, FIG. 1 is a flowchart of a signal adjustment method according to an embodiment.

In this embodiment, the signal adjustment method includes steps of S101, S102, S103 and 104, which are detailed as follows:

Step S101. Input a clock signal and a current row data signal, and identify transmission amplitudes of data signals at clock signal edges.

In this embodiment, the current row data signal refers to a row of data signals transmitted at present. In step S101, a row of data signal transmitted at present and the clock signal are received, and the transmission amplitudes of data signals are identified at the clock signal edges. The clock signal edges include a rising edge or a falling edge of a clock. Specifically, the rising edge and the falling edge of the clock signal are detected, and the transmission amplitudes of the data signals are identified when the rising edge or the falling edge of the clock is detected.

Step S102. Convert the transmission amplitudes into corresponding digits.

In this embodiment, the transmission amplitudes of the data signal are identified in step S101, then in step S102, specific sizes of transmission amplitudes are converted into a digital representation form. In an embodiment, an analog value of each transmission amplitude is converted into a digital value by using an analog-to-digital converter.

Step S103. Calculate the digits to obtain digital information of the transmission amplitudes.

In this embodiment, the digits are calculated, the digital information corresponding to the transmission amplitudes of row data is acquired in step S103, and the digital information is fed back to step S104. The digital information refers to digitized information of the overall transmission amplitudes the current row data signal, which is obtained by calculating the digits. The calculation method includes but is not limited to a mean value method, a weighting method, and a combination thereof, and the method is selected and set specifically according to a data transmission status. The digital information can be transmitted in real time in step S103, real-time and accurate adjustment can be performed to improve delay accuracy. The digital information may be selectively fed back in an idle time in a horizontal or vertical direction during a non-data transmission period to avoid impacts on data transmission.

Step S104. Correspondingly adjust and output the transmission amplitudes of the data signals according to the digital information.

In this embodiment, in step S104, the digital information is received, the transmission amplitudes of the data signals output by a data transmission transmitting end are correspondingly adjusted according to the digital information to meet a transmission requirement, so that a data transmission receiving end can reliably collect data. Meanwhile, excessive manual debugging is not needed with the help of automatic adjustment so as to save time and labor.

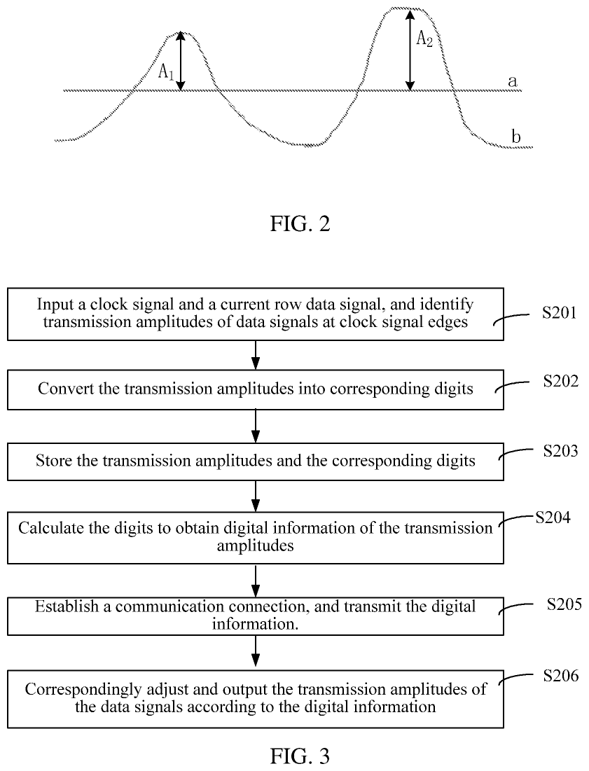

The correspondingly adjusting the transmission amplitudes according to the digital information refers to adjusting the digital information until it is the same as preset digital information, so that the output transmission amplitude is the same as an amplitude corresponding to the preset digital information. The preset digital information is set according to an actual data transmission status, that is, different data transmission statuses correspond to different preset digital information. Different data transmission statuses correspond to different amplitude ranges which include a plurality of thresholds, such as a first threshold (lowest threshold), a second threshold (medium threshold), a third threshold (highest threshold), etc. In an embodiment, the preset digital information corresponds to the first threshold (lowest threshold) of a transmission amplitude of a data signal, that is, the transmission amplitude of the data signal output by the data transmission transmitting end is adjusted according to the digital information, so that the amplitude can meet the requirement of the lowest threshold of the transmission amplitude of the data signal. For example, referring to FIG. 2, FIG. 2 is an effect diagram of adjustment of data transmission amplitudes (in the figure, curve a represents an amplitude reference, and curve b represents a data transmission line). A1 refers to a transmission amplitude before automatic adjustment, A2 is a transmission amplitude before automatic adjustment, and a transmission amplitude of a data signal is increased from A1 to A2, to meet a transmission requirement.

According to the signal adjustment method provided by this embodiment, the transmission amplitudes of the data signals are identified at the clock signal edges, the transmission amplitudes are converted into the corresponding digits, and the digits are calculated to obtain the digital information of the transmission amplitude, so that the transmission amplitudes of the data signals can be correspondingly adjusted and output according to the digital information, the transmission amplitude can meet the transmission requirement, and the data transmission receiving end can reliably collect data, thereby improving data transmission quality. Different amplitudes are chosen according to different data transmission statuses to realize adaptive dynamic matching and meet an eye diagram requirement under various data transmission statuses. Meanwhile, excessive manual debugging is not needed with the help of automatic adjustment, so as to save time and labor.

Referring to FIG. 3, FIG. 3 is a flowchart of a signal adjustment method according to another embodiment.

In this embodiment, the signal adjustment method includes steps of: S201, S202, S203, S204, S205 and S206, which are detailed as follows:

Step S201. Input a clock signal and a current row data signal, and identify transmission amplitudes of data signals at clock signal edges.

Step S202. Convert the transmission amplitudes into corresponding digits.

Step S203. Store the transmission amplitudes and the corresponding digits.

Step S204. Calculate the digits to obtain digital information of the transmission amplitudes.

Step S205. Establish a communication connection, and transmit the digital information.

Step S206. Correspondingly adjust and output the transmission amplitudes of the data signals according to the digital information.

In this embodiment, for related descriptions of steps S201, S202, S204 and S206, refer to corresponding related descriptions of steps S101, S102, S103 and S104 in the previous embodiment, and no more detailed description will be given herein. The order of the precedence of steps S201, S202, S203, S204, S205 and S206 is not limited.

In this embodiment, in step S203, each transmission amplitude and the corresponding digit are stored to avoid data loss; on the other hand, more digits may be accumulated by storing, so that more digits can be calculated in step S204, and the accuracy and efficiency of calculation will be improved.

In this embodiment, specifically, a communication connection may be established, and the digital information may be transmitted in real time in step S205; or a communication connection is established, and the digital information is transmitted when the transmission of the current row data signal is stopped. Specifically, when the transmission of the current row data signal is stopped, transmitted digital information includes the digital information acquired according to a current data signal, and may also include digital information corresponding to other row of data signals accumulated by storing. The communication connection may be established by using a bidirectional communication protocol which includes but is not limited to an I²C protocol. During application of the communication protocol, lines of the communication protocol and transmission data are separated and do not interfere with each other, so the digital information may be transmitted in real time when data are transmitted simultaneously to achieve real-time and accurate adjustment.

According to the signal adjustment method provided by this embodiment, the transmission amplitudes of the data signals are identified at the clock signal edges, the transmission amplitudes are converted into the corresponding digits, and the digits are stored and calculated to obtain the digital information of the transmission amplitudes, so that the transmission amplitudes of the data signals can be correspondingly adjusted and output according to the digital information, to meet a transmission requirement. The data transmission receiving end can reliably collect data, and data transmission quality can be improved; and different amplitudes are chosen according to different data transmission statuses to realize adaptive dynamic matching and meet an eye diagram requirement under various data transmission statuses. Meanwhile, excessive manual debugging is not needed with the help of automatic adjustment so as to save time and labor.

It should be understood that although the steps in the flowcharts of the foregoing embodiments are sequentially displayed in accordance with the indication of the arrows, these steps are not necessarily performed in the order indicated by the arrows. Unless otherwise specified in the specification, the execution of these steps is not strictly limited, and the steps may be performed in other orders. Moreover, at least some of the steps in FIG. 1 and FIG. 3 may include a plurality of sub-steps or stages, which are not necessarily performed at the same time, but may be performed at different time. The sub-steps or stages do need to be all performed sequentially, but may be performed sequentially or alternately with at least some of other steps or the sub-steps or stages of the other steps.

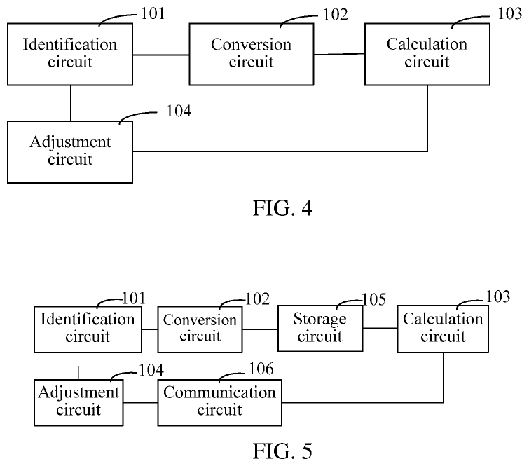

Referring to FIG. 4, FIG. 4 is a structural diagram of a signal adjustment circuit for correspondingly executing various steps in the embodiment referred by FIG. 1.

In this embodiment, the signal adjustment circuit includes: an identification circuit 101, a conversion circuit 102, a calculation circuit 103, and an adjustment circuit 104. The identification circuit 101, the conversion circuit 102, and the calculation circuit 103 are disposed at a data transmission receiving end, and the adjustment circuit 104 is disposed at a data transmission transmitting end. In an embodiment, the identification circuit 101, the conversion circuit 102 and the calculation circuit 103 of the signal adjustment circuit are disposed in a data driver, and the adjustment circuit 104 is disposed in a timing controller.

The identification circuit 101 is configured to input a clock signal and a current row data signal, and identify transmission amplitudes of data signals at clock signal edges.

The conversion circuit 102 is connected to the identification circuit 101 and configured to convert the transmission amplitudes into corresponding digits.

The calculation circuit 103 is connected to the conversion circuit 102 and configured to calculate the digits to obtain digital information of the transmission amplitudes.

The adjustment circuit 104 is connected to the calculation circuit 103 and configured to correspondingly adjust and output the transmission amplitudes of the data signals according to the digital information.

In this embodiment, the identification circuit 101 is disposed at the data transmission receiving end and configured to receive the transmitted data signal and the clock signal, and identify the transmission amplitudes of the data signals at the clock edges. Specifically, the rising edge and the falling edge of the clock signal are detected, and the transmission amplitudes of the data signals are identified when the rising edge or the falling edge of the clock is detected.

In an embodiment, the conversion circuit 102 is configured to convert the transmission amplitudes into corresponding digits. Specifically, the conversion circuit 102 identifies the transmission amplitudes of the data signals by using the identification circuit 101 and converts specific sizes of the transmission amplitudes into a digital representation form. The conversion circuit 102 may be specifically an analog-to-digital converter, which converts an analog value of each transmission amplitude into a digital value.

In this embodiment, the calculation circuit 103 is configured to receive and calculate the digits, corresponding to the transmission amplitudes, and obtained through conversion performed by the conversion circuit 102, to acquire the digital information corresponding to a transmission amplitude of row data, and feed the digital information back to the adjustment circuit 104. The calculation method includes but is not limited to a mean value method, a weighting method and a combination thereof, and the method is selected and set specifically according to a data transmission status. During feedback performed by the calculation circuit 103 to the adjustment circuit 104, time information can be transmitted in real time, and real-time and accurate adjustment can be performed to improve delay accuracy. The digital information may be selectively fed back in an idle time in a horizontal or vertical direction during a non-data transmission period to avoid impacts on data transmission.

In this embodiment, the adjustment circuit 104 is disposed at the data transmission transmitting end, and configured to receive the digital information fed back by the calculation circuit 103, and to correspondingly adjust and output the transmission amplitudes of the data signal according to the digital information, so that the transmission amplitudes of the data signal meet the transmission requirement and the data transmission receiving end can reliably collect data. Meanwhile, excessive manual debugging is not needed with the help of automatic adjustment so as to save time and labor.

The correspondingly adjusting the transmission amplitudes according to the digital information refers to adjusting the digital information until it is the same as preset digital information, so that the output transmission amplitude is the same as an amplitude corresponding to the preset digital information. The preset digital information is set according to an actual data transmission status, that is, different data transmission statuses correspond to different preset digital information. Different data transmission statuses correspond to different amplitude ranges which include a plurality of thresholds, such as a first threshold (lowest threshold), a second threshold (medium threshold), a third threshold (highest threshold), etc. In an embodiment, the preset digital information corresponds to the first threshold (lowest threshold) of a transmission amplitude of a data signal, that is, the transmission amplitude of the data signal output by the data transmission transmitting end is adjusted according to the digital information, so that the amplitude can meet the requirement of the lowest threshold of the transmission amplitude of the data signal.

The signal adjustment circuit provided by this embodiment includes the identification circuit 101, the conversion circuit 102, the calculation circuit 103, and the adjustment circuit 104. The transmission amplitudes of the data signals are identified at the clock edges by the identification circuit 101, the transmission amplitudes are converted into the corresponding digits by the conversion circuit 102, and the digits are calculated by the calculation circuit 103 to acquire the digital information of the transmission amplitudes, so that the adjustment circuit 104 can correspondingly adjust and output the transmission amplitudes of the data signals according to the digital information to meet a transmission requirement, the data transmission receiving end can reliably collect data, thereby improving data transmission quality. Different amplitudes are chosen according to different data transmission statuses to realize adaptive dynamic matching and meet an eye diagram requirement under various data transmission statuses. Meanwhile, excessive manual debugging is not needed with the help of automatic adjustment so as to save time and labor.

Referring to FIG. 5, FIG. 5 is a structural diagram of a signal adjustment circuit for correspondingly executing steps of the embodiment referred by FIG. 3 according to another embodiment.

In this embodiment, the signal adjustment circuit includes an identification circuit 101, a conversion circuit 102, a calculation circuit 103, an adjustment circuit 104, a storage circuit 105, and a communication circuit 106.

In this embodiment, for related descriptions of the identification circuit 101, the conversion circuit 102, the calculation circuit 103, and the adjustment circuit 104, refer to the previous embodiment, and no more detailed descriptions will be given herein.

In this embodiment, the storage circuit 105 is connected between the conversion circuit 102 and the calculation circuit 103 and configured to store the transmission amplitudes and the corresponding digits. On one hand, the identification circuit 101 receives a lot of data signals at a time, so that a plurality of transmission amplitudes can be identified. The transmission amplitudes and the corresponding digits can be stored by the storage circuit 105 to avoid data loss. On the other hand, more digits can be accumulated by storing, so that more digits can be calculated by the calculation circuit 103, and the accuracy and efficiency of calculation will be improved.

In this embodiment, the communication circuit 106 is configured to establish a communication connection between the calculation circuit 103 and the adjustment circuit 104, and transmit digital information. Specifically, the communication circuit 106 can comply with a bidirectional communication protocol, which includes but is not limited to an I²C protocol. During application of the communication protocol, lines of the communication protocol and the transmission data are separated and do not interfere with each other, so the time information can be transmitted in real time when data are transmitted simultaneously to realize real-time accurate adjustment.

The signal adjustment circuit provided by this embodiment includes the identification circuit 101, the conversion circuit 102, the calculation circuit 103, the adjustment circuit 104, the storage circuit 105, and the communication circuit 106. The transmission amplitudes of the data signals are identified at the clock edges by the identification circuit 101, the transmission amplitudes are converted into the corresponding digits and then stored by a combination of conversion circuit 102 and the storage circuit 105, the digits are calculated by the calculation circuit 103 to obtain the digital information of transmission amplitudes, so that the adjustment circuit 104 can correspondingly adjust and output the transmission amplitudes of the data signals according to the digital information to meet the transmission requirement, and the data transmission receiving end can reliably collect data, thereby data transmission quality can be improved. Different amplitudes are chosen according to different data transmission statuses to realize adaptive dynamic matching and meet an eye diagram requirement under various data transmission statuses. Meanwhile, excessive manual debugging is not needed with the help of automatic adjustment so as to save time and labor.

This embodiment further provides a display device, including a display panel and the signal adjustment circuit described in the embodiments above, to ensure correct receiving of each displayed batch of data and improve display reliability.

The display panel described in this embodiment may be any of the following: a liquid crystal display panel, an OLED display panel, a QLED display panel, a Twisted Nematic (TN) display panel, a Super Twisted Nematic (STN) display panel, an In-Plane Switching (IPS) display panel, a Vertical Alignment (VA) display panel, a curved display panel, or other display panels.

Technical features in the foregoing embodiments may be combined randomly. For the brevity of description, not all possible combinations of various technical features in the foregoing embodiments are described. However, provided that combinations of these technical features do not contradict each other, it should be considered that the combinations all fall within the scope of this specification.

The foregoing embodiments only show several implementations of this application and are described in detail, but they should not be construed as a limit to the patent scope of this application. It should be noted that, a person of ordinary skill in the art may make various changes and improvements without departing from the ideas of this application, which shall all fall within the protection scope of this application. Therefore, the protection scope of the patent of this application shall be subject to the appended claims.

What is claimed is:

1. A signal adjustment method, comprising the following steps of:
inputting a clock signal and a current row data signal, and identifying transmission amplitudes of data signals at clock signal edges;
converting the transmission amplitudes into corresponding digits;
calculating the digits to obtain digital information of the transmission amplitudes; and
correspondingly adjusting and outputting the transmission amplitudes of the data signals according to the digital information.

2. The signal adjustment method according to claim 1, wherein after the step of converting the transmission amplitudes into corresponding digits, the method comprises: storing the transmission amplitudes and the corresponding digits thereof.

3. The signal adjustment method according to claim 1, wherein after the step of calculating the digits to obtain digital information of the transmission amplitudes, the method comprises:
establishing a communication connection, and transmitting the digital information.

4. The signal adjustment method according to claim 3, wherein the step of establishing a communication connection, and transmitting the digital information specifically comprises:
establishing a communication connection, and transmitting the digital information in real time; or
establishing a communication connection, and transmitting the digital information when transmission of the current row data signal is stopped.

5. The signal adjustment method according to claim 4, wherein a communication connection is established by using a bidirectional communication protocol.

6. The signal adjustment method according to claim 1, wherein the step of correspondingly adjusting and outputting the transmission amplitudes of the data signals according to the digital information specifically comprises:
adjusting the digital information to be the same as a preset digital information such that the transmission amplitude of the data signal is the same as an amplitude corresponding to the preset digital information.

7. The signal adjustment method according to claim 6, wherein the amplitude corresponding to the preset digital information is a first threshold.

8. The signal adjustment method according to claim 1, wherein the clock signal edges comprise a rising edge and a falling edge.

9. The signal adjustment method according to claim 1, wherein a calculation method comprises at least one of a mean value method and a weighting method.

10. A signal adjustment circuit, comprising:
an identification circuit, configured to input a clock signal and a current row data signal, and identify transmission amplitudes of data signals at clock signal edges;
a conversion circuit, connected to the identification circuit and configured to convert the transmission amplitudes into corresponding digits;
a calculation circuit, connected to the conversion circuit and configured to calculate the digits to obtain digital information of the transmission amplitudes; and
an adjustment circuit, connected to the identification circuit and the calculation circuit respectively and configured to correspondingly adjust and output the transmission amplitudes of the data signals according to the digital information.

11. The signal adjustment circuit according to claim 10, wherein the signal adjustment circuit further comprises:
a storage circuit, connected between the conversion circuit and the calculation circuit and configured to store the transmission amplitudes and the corresponding digits.

12. The signal adjustment circuit according to claim 10, wherein the signal adjustment circuit further comprises:
a communication circuit, connected between the calculation circuit and the adjustment circuit and configured to establish a communication connection between the calculation circuit and the adjustment circuit, and transmit the digital information.

13. The signal adjustment circuit according to claim 10, wherein the communication circuit comprises a bidirectional communication protocol.

14. The signal adjustment circuit according to claim 13, wherein the communication circuit comprises an inter-integrated circuit (I²C) protocol.

15. The signal adjustment circuit according to claim 10, wherein the conversion circuit comprises an analog-to-digital converter.

16. The signal adjustment circuit according to claim 10, wherein the clock signal edges comprise a rising edge and a falling edge.

17. A display device, comprising a display panel and the signal adjustment circuit according to claim 10.
